(19) United States
(12) Patent Application Publication
(10) Pub. No.: US 2012/0239200 A1
(43) Pub. Date: Sep. 20, 2012

(54) REMOTE OBJECT VIBRO-KINETIC FEEDBACK SYSTEM AND METHOD

(75) Inventor: M. Jean-Francois Ménard, Boucherville (CA)

(73) Assignee: D-Box Technologies Inc., Longueuil (CA)

(21) Appl. No.: 13/192,454

(22) Filed: Jul. 27, 2011

Related U.S. Application Data
(63) Continuation-in-part of application No. 13/036,118, filed on Feb. 28, 2011.

(51) Int. Cl. G05B 15/02

(52) U.S. Cl. 700/275

(57) ABSTRACT

The present document describes a system and method for rendering a vibro-kinetic feedback representative of the vibro-kinetic properties of a remote object on a vibro-kinetic platform. The user may control the motion of the remote object using a remote control such as a joystick or the like. Motion commands generated by the remote control are sent to the remote object for execution. Telemetry data representative of measurements related to the remote object may be captured by a telemetry capture system. A vibro-kinetic encoder generates, using the telemetry data, a vibro-kinetic signal representative of the vibro-kinetic properties of the remote object for rendering on the vibro-kinetic platform. The vibro-kinetic platform may be a motion-enabled chair, or a vibro-kinetic platform having the shape of the remote object for more realistic effect. In an embodiment, the audio and/or video environments of the remote object are also captured and rendered on a feedback system.

### CROSS-REFERENCE TO RELATED APPLICATIONS

This application claims priority under 35USC§119(e) of U.S. non-provisional patent application Ser. No. 13/036,118 filed on Feb. 28, 2011, the specification of which is hereby incorporated by reference.

### BACKGROUND

(a) Field

The subject matter disclosed generally relates to the field of vibro-kinetic platforms.

(b) Related Prior Art

It is becoming more and more popular to use motion-enabled chairs in theatres (or at home) to experience movements that are synchronized with the events displayed on the screen. An example of such motion-enabled chairs is described in co-owned U.S. Patent Publication No. 20100090507 entitled Motion-Enabled Movie Theatre Seat, which is incorporated herein by reference in its entirety.

Generally, motion-enabled chairs (or vibro-kinetic platforms) include one or more actuators connected to the base of the seat to produce vibrations and movements which are synchronized with and correspond to the events displayed on the screen. The actuators are driven by a vibro-kinetic signal. The vibro-kinetic signals are generated by a central controller to induce and synchronize the vibrations/movements with the events displayed on the screen.

In this type of systems, the movements of the chair are pre-programmed. In other words, the central controller generates a vibro-kinetic signal in accordance with commands which are pre-entered by a motion designer or a programmer. Generally, the motion designer or programmer watches the video and enters movements and vibrations where they feel appropriate.

Because in these types of applications, movements and vibrations are pre-programmed, they do not easily lend themselves to use the vibro-kinetic platforms in real time.

Accordingly there is a need for a system and method which enable a user to experience real-time performance based on the movements of a real object that is controlled remotely by the user.

### SUMMARY

According to an aspect, the systems and methods described herein aim to reproduce the immersive effect of being present in a real object such as a remote vehicle. The immersive effect is reproduced for a real object or vehicle of a similar or of a different size or model.

Vibro-kinetic platforms are meant to include any platform or seating arrangement to which motion and/or tactile feedback is induced by any combination of actuators, tactile transducers and inertial shakers and on which a person is installed. An example of a vibro-kinetic platform includes a seat or chair for one or more persons on which are mounted one or more actuators which interface with the ground. Another example would be a platform for receiving a seat, chair or other device accommodating a user, and on which are mounted one or more actuators which interface with the ground. According to an embodiment, the vibro-kinetic platforms may have the shape of the remote object for more realistic effect. An example of a shape of a remote object would include a vehicle cockpit such a racing car cockpit, aircraft cockpit, helicopter cockpit, etc.

According to an embodiment, there is provided a system for rendering a vibro-kinetic feedback representative of vibro-kinetic properties of a remote object. The system comprises: a telemetry capture system for capturing telemetry data representative of measurements related to the remote object; a vibro-kinetic encoder for generating, using the telemetry data, a vibro-kinetic signal representative of the vibro-kinetic properties of the remote object; and a vibro-kinetic platform to render, from the vibro-kinetic signal, the vibro-kinetic feedback representative of the vibro-kinetic properties of the remote object.

According to another embodiment, the system further comprises a control interface for generating control data for controlling motion of the remote object.

According to another embodiment, the control interface comprises at least one of: a joystick, a steering wheel, pedals, and a keyboard.

According to another embodiment, the control interface is embedded within the vibro-kinetic platform.

According to another embodiment, the control interface is separate from the vibro-kinetic platform.

According to another embodiment, the system further comprises: a video capture system for capturing a video environment of the remote object; and a video playback system for reproducing video environment of the remote object; wherein the vibro-kinetic encoder generates the vibro-kinetic signal such that the vibro-kinetic feedback is rendered synchronously with the reproduced video environment.

According to another embodiment, the system further comprises: an audio capture system for capturing audio environment of the remote object; and an audio playback system for reproducing the audio environment of the remote object; wherein the vibro-kinetic encoder generates the vibro-kinetic signal such that the vibro-kinetic feedback is rendered synchronously with the reproduces audio environment.

According to another embodiment, the vibro-kinetic platform is at a local site and the remote object is at a remote site remote from the local site.

According to another embodiment, the system further comprises a communication link for enabling communication between the local site and the remote site, the communication link comprising at least one of: a Bluetooth link, a WiFi link, a wireless link, an optical link, a wired link, an internet link, an Ethernet link, a radio-frequency link and an infra-red link.

According to another embodiment, the vibro-kinetic platform comprises a motion-enabled chair.

According to another embodiment, the vibro-kinetic platform comprises a shape of the remote object.

According to another embodiment, there is provided a method for rendering a vibro-kinetic feedback representative of the vibro-kinetic properties of the remote object on a vibro-kinetic platform. The method comprises: receiving telemetry data representative of measurements related to the remote object; generating, using the telemetry data, a vibro-kinetic signal representative of the vibro-kinetic properties of the remote object; and rendering, from the vibro-kinetic signal, the vibro-kinetic feedback representative of the vibro-kinetic properties of the remote object on the vibro-kinetic platform.

According to another embodiment, the method further comprises generating control data for execution by the remote object thereby controlling motion of the remote object.

According to another embodiment, the method further comprises capturing telemetry data by reading data from one or more sensors installed on the remote object.

According to another embodiment, the method further comprises capturing video data representative of a video environment of the remote object; and synchronously rendering the video environment at a video playback system and the vibro-kinetic feedback at the vibro-kinetic platform.

According to another embodiment, the method further comprises: capturing audio data representative of an audio environment of the remote object; and synchronously rendering the audio environment at an audio playback system and vibro-kinetic feedback at the vibro-kinetic platform.

According to another embodiment, the method further comprises transmitting the captured telemetry data to a vibro-kinetic encoder over a communication link.

According to another embodiment, the capturing telemetry data comprises capturing telemetry data representative of movements of the remote object in a range of frequencies between about 0 Hz and 600 Hz.

According to another embodiment, the capturing telemetry data comprises capturing telemetry data representative of movements of the remote object in a range of frequencies between about 0 Hz and 100 Hz.

According to another embodiment, the method further comprises processing at least one of the captured video data and the captured audio data to obtain computed telemetry data representative of measurements of the remote object.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

FIG. 1 is a perspective view showing an example of a motion-enabled chair that may be used as a vibro-kinetic platform in one of the embodiments;

FIGS. 2A and 2B are pictures showing examples of remote controls/control interfaces that may be used with the present embodiments;

FIG. 3 is a block diagram showing a remote object vibro-kinetic feedback system according to an embodiment;

FIG. 4 is a block diagram showing a method for rendering a vibro-kinetic feedback representative of the vibro-kinetic properties of the remote object on a vibro-kinetic platform according to an embodiment;

FIG. 5 is a block diagram showing a remote object vibro-kinetic feedback system with video and audio rendering; and

FIG. 6 is a block diagram showing a method for rendering a vibro-kinetic feedback representative of the vibro-kinetic properties of the remote object on a vibro-kinetic platform and rendering audio and video of that object on a feedback system according to an embodiment.

It will be noted that throughout the appended drawings, like features are identified by like reference numerals.

### DETAILED DESCRIPTION

The present document describes a system and method for rendering a vibro-kinetic feedback representative of the vibro-kinetic properties of a remote object on a vibro-kinetic platform. The user may control the motion of the remote object using a remote control / control interface such as a joystick or the like. Control data generated by the control interface are sent to the remote object for execution. Telemetry data representative of measurements related to the remote object may be captured by a telemetry capture system. A vibro-kinetic encoder generates, using the telemetry data, a vibro-kinetic signal representative of the vibro-kinetic properties of the remote object for rendering on the vibro-kinetic platform.

In an embodiment, the audio and/or video environments of the remote object are also captured and rendered on a feedback system. Communication between the motion, audio and video capture systems and their respective playback systems may be effected over a communications network such as: a Bluetooth link, a WiFi link, a wireless link, an optical link, a wired link, an internet link, an Ethernet link, a radio-frequency link and/or an infra-red link.

The following embodiments are described with reference to a vibro-kinetic platform which includes, as a non limiting example, a motion-enabled chair. Different platforms and/or chairs may be used in the present embodiments without departing from the scope of this document. Other examples of vibro-kinetic platforms include shakers and tactile transducers.

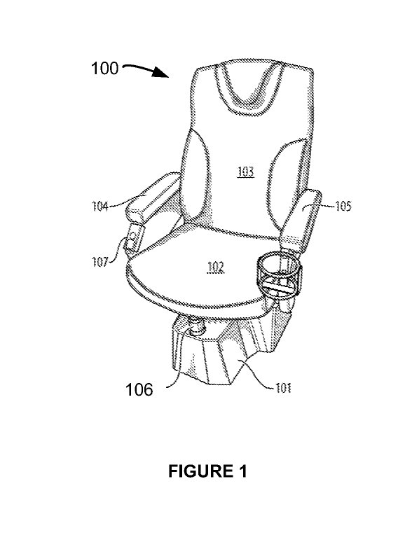

FIG. 1 illustrates an example of a vibro-kinetic platform 100 as shown in co-owned U.S. Patent Publication No. 20100090507. In the example shown in FIG. 1, the base (not shown) of the vibro-kinetic platform 100 is covered by a protective cover 101. The seating portion of the vibro-kinetic platform 100 is very similar to a standard movie chair or seat and comprises a seat base 102, a backrest 103 and armrests 104-105. Between the protective cover 101 and the seat base 102 there may be a protection skirt (not shown) for preventing users from injury while viewing a moving which comprising vibro-kinetic effects (aka vibro-kinetic feedback). The protection skirt is horizontally wrinkled and made of flexible material to adjust itself during the actuating (i.e., movement of the chair).

The vibro-kinetic platform 100 includes one or more actuators 106 connected to the seat base 102, and a controller (not shown) to receive a vibro-kinetic signal from a vibro-kinetic encoder (not shown) and interpret and transform the vibro-kinetic signal into drive signals for driving each actuator 106. The vibro-kinetic encoder generates the vibro-kinetic signal in accordance with the movements of a remote subject as will be described herein. Normally, a video and audio system (not shown) accompanies the vibro-kinetic platform 100 to enhance the immersive effect to the user.

Below the right armrest 104, a control panel 107 is accessible to the user for controlling the intensity (e.g., the amplitude range of the actuators 106) of the vibro-kinetic effect inducing in the vibro-kinetic platform 100. Some of the options (i.e., modes of operation) include “Off” (i.e., no motion), “Light” (i.e., reduced motion), “Normal” (i.e., regular motion), “Heavy” (i.e., maximum motion), “Discreet” (i.e., fully controllable motion level between “Off” and “Heavy”), and “Automatic”. In the “Automatic” mode, the vibro-kinetic platform 100 uses a sensor (not shown) to detect a characteristic of the user (e.g., weight, height etc.) and, based on the characteristic, determines the setting for the level of motion/vibro-kinetic feedback that will be induced in the vibro-kinetic platform 100.

The present embodiments describe a system which allows a user sitting on a vibro-kinetic platform 100 such as that shown in FIG. 1, to control the displacement/motion of a remote object and experience the vibro-kinetic feedback representative of the vibro-kinetic properties of the remote object in the vibro-kinetic platform 100 in real time.

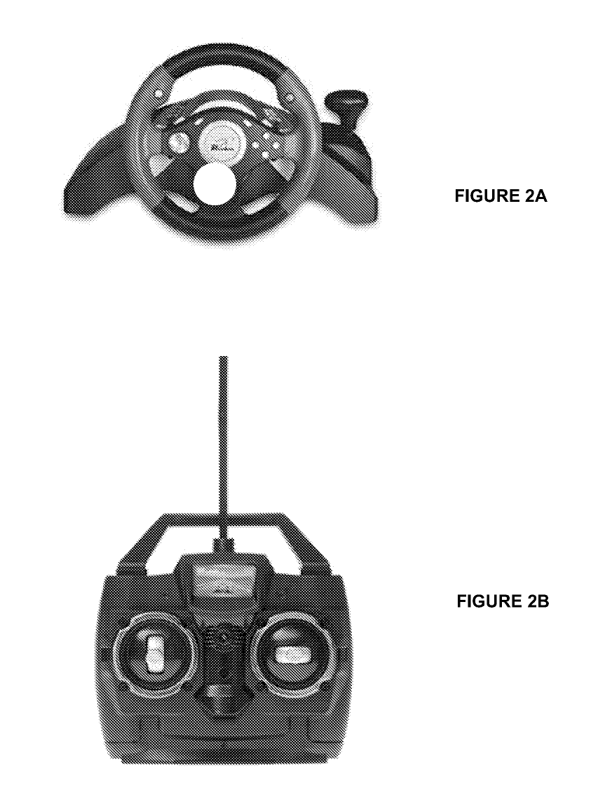

FIGS. 2A and 2B illustrate examples of remote controls/control interfaces that may be operated by a user with the present embodiments. The remote control may be in the form of a steering wheel as shown in FIG. 2A, a joystick as shown in FIG. 2B, or any other user-interface that may be used to control the motion of a remote object. Generally, the remote control may includes push-buttons, wheels, pedals, control sticks or a combination thereof to control one or more of the following motion parameters of the remote object: speed, acceleration, deceleration, direction of travel (left, right, up, down, forward, backward), etc.

The remote control may be provided as an independent piece which is separate from the vibro-kinetic platform 100, or may be attached and/or embedded within the vibro-kinetic platform 100 as one piece.

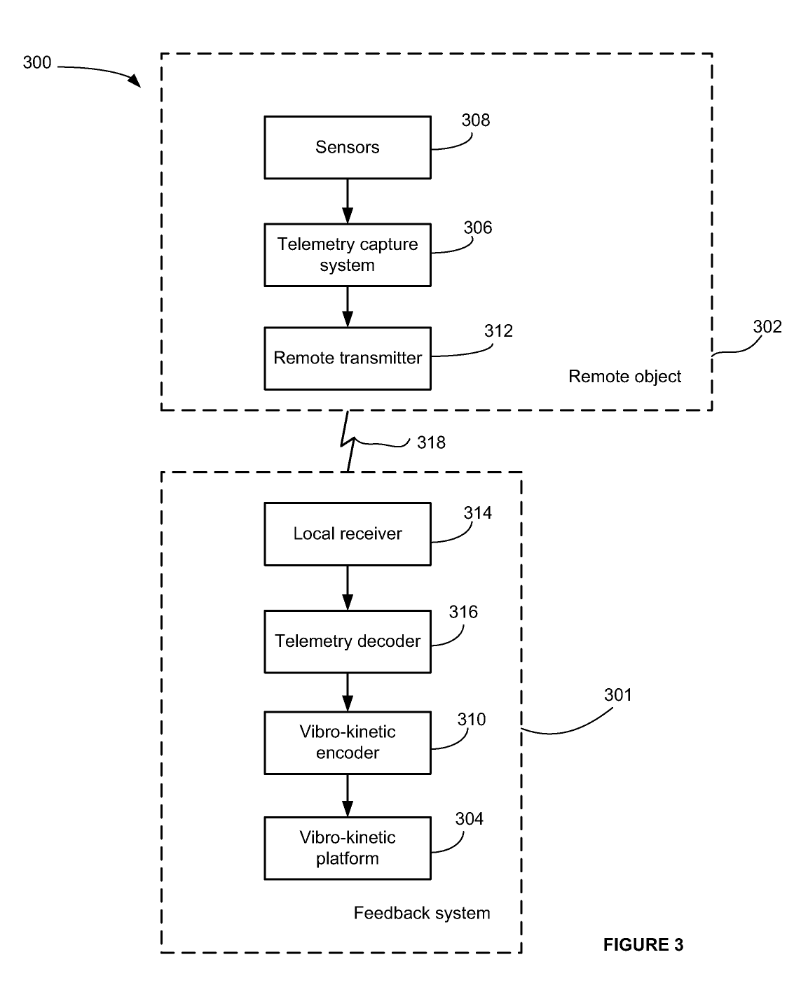

FIG. 3 illustrates an embodiment of a system 300 comprising a feedback system 301 for rendering a vibro-kinetic feedback representative of vibro-kinetic properties of a remote object 302 which allows a user to control the motion of the remote object 302 and at the same time experience motions and/or vibrations (i.e., vibro-kinetic feedback) which correspond to the motion of the remote object 302 (i.e., the vibro-kinetic properties of the remote object 302) on a vibro-kinetic platform 304, in real time.

As shown in FIG. 3, the system 300 comprises a telemetry capture system 306 for capturing telemetry data representative of measurements related to the remote object 302. According to an embodiment, the telemetry capture system 306 obtains its data from one or more motion sensors 308 installed on the remote object 302.

The system 300 further comprises a vibro-kinetic encoder 310 for generating, using the telemetry data, a vibro-kinetic signal representative of the vibro-kinetic properties of the remote object 302.

According to an embodiment, the telemetry data is transmitted from the remote object 302 by a remote transmitter 312 over a communications link or network 318. According to an embodiment, the communications link or network 318 is the Internet. According to another embodiment, the communications link or network 318 is a wireless radio link. However, any other type of broadcast communication networks can also be used (wired or wireless). Examples of links include: a Bluetooth link, a WiFi link, a wireless link, an optical link, a wired link, an internet link, an Ethernet link, an IR link, an RF link, etc.

The telemetry data is received in the feedback system 301 by a local receiver 314. According to an embodiment, the telemetry data is then decoded by the telemetry decoder 316 before being forwarded to the vibro-kinetic encoder 310. The telemetry decoder 316 formats the signal so that it can be used by the vibro-kinetic encoder 510. According to another embodiment the telemetry decoder 316 is incorporated directly within local receiver 314.

The system 300 further comprises a vibro-kinetic platform 304 to render, from the vibro-kinetic signal, the vibro-kinetic feedback representative of the vibro-kinetic properties of the remote object 302. The vibro-kinetic platform 304 will not be further described here as it can be the same as the vibro-kinetic platform 100 of FIG. 1.

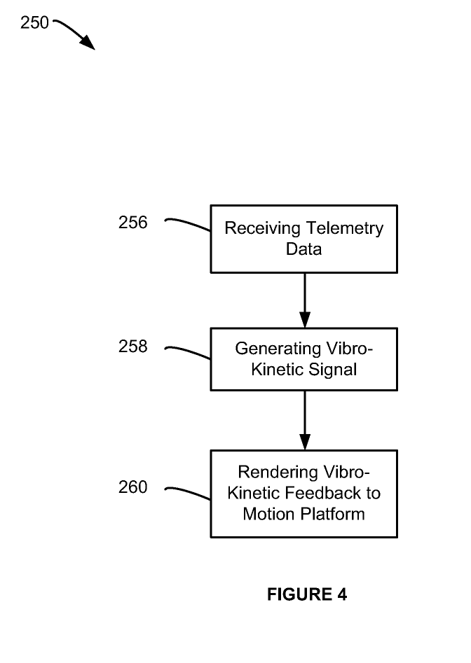

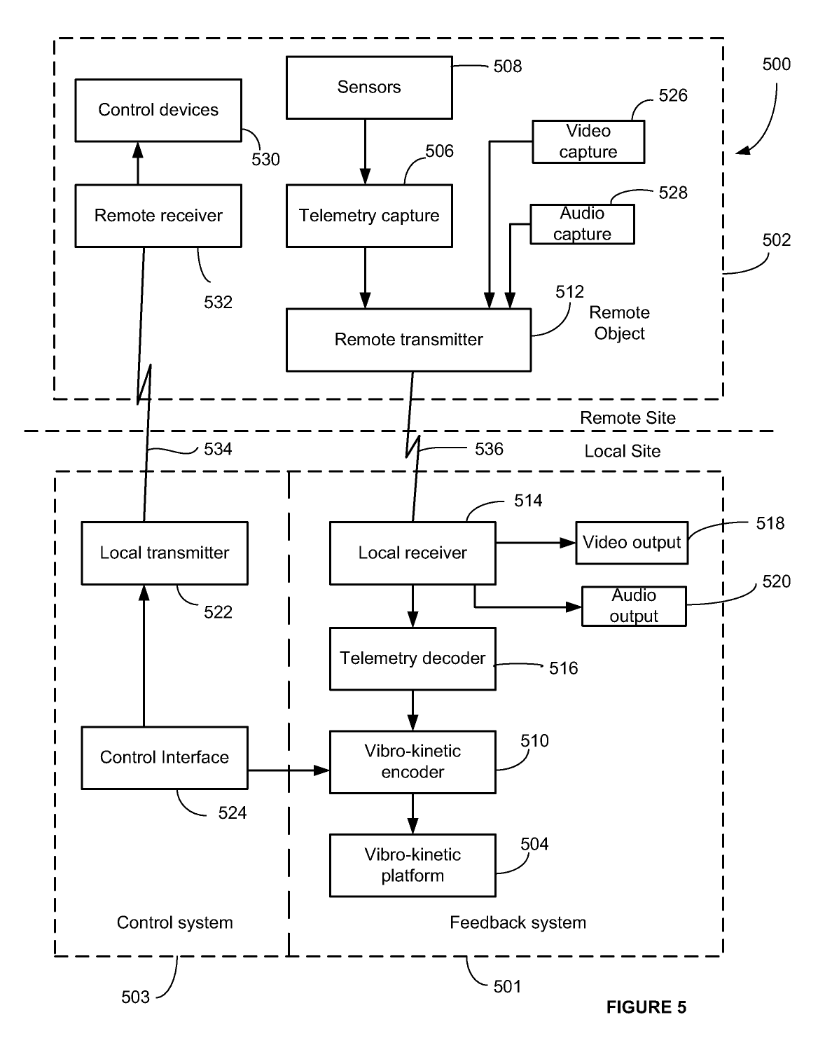

FIG. 4 illustrates a block diagram illustrating a method 250 for rendering a vibro-kinetic feedback representative of the vibro-kinetic properties of the remote object on a vibro-kinetic platform. Refer to FIGS. 3 and 5 for the physical context of the method.

The method 250 comprises receiving telemetry data representative of measurements related to the remote object (step 256); generating, using the telemetry data, a vibro-kinetic signal representative of the vibro-kinetic properties of the remote object (step 258); and rendering, from the vibro-kinetic signal, the vibro-kinetic feedback representative of the vibro-kinetic properties of the remote object on the vibro-kinetic platform (step 260).

As shown in FIG. 5, the system 500 comprises, at a local site, a feedback system 501 and a control system 503 for controlling the motion of a remote object 502 at a remote site. The feedback system 501 comprises a vibro-kinetic platform 504, a vibro-kinetic encoder 510, a telemetry decoder 516, a local receiver 514, a video playback system 518 and an audio playback system 520. The control system 503 comprises a control interface 524 and a local transmitter 522.

The remote object, for its part, comprises a remote transmitter 512, a telemetry capture system 506, motion sensors 508, audio capture equipment 528, video capture equipment 526, a remote receiver 532 and control devices 530.

Control commands entered by the user through the control interface 524 are sent to a local transmitter 522 at the local site. The local transmitter 522 forwards the control commands to remote receiver 532 at the remote site using a communications link or network 534. According to an embodiment, the communications link or network 534 is the Internet. According to another embodiment, the communications link or network 534 is a wireless radio link. However, any other type of broadcast communication networks can also be used (wired or wireless). The vibro-kinetic platform 504 will not be further described here as it can be the same as the vibro-kinetic platform 100 of FIG. 1.

On the control side, the remote receiver 532 at the remote site is connected to the control devices 530 of the remote object 502 and thereby transmits the control commands thereto. The control commands allow the user to control the motion of the remote object 502 remotely. While the remote receiver 532 and the control devices 530 are shown as separate modules, it is also possible to have them combined with or built in the same modules.

On the capture side, motion of the remote object 502 is captured by a telemetry capture system 506. The telemetry capture system 506 is for capturing telemetry data representative of movements of the remote object 502.

In an embodiment, the remote object 502 may be equipped with motion sensors 508 which communicate with the telemetry capture system 506 to transmit information relating to their motion in real-time. The motion sensors 508 may be selected from a wide variety of sensors available on the market such as accelerometers, gyrometers, magnetometers, inclinometers, and rotational or translational encoders.

In another embodiment, the telemetry capture system 506 determines the motion of the remote object 502 object based on a graphical processing of real-time images of the object using a camera (not shown), as described in U.S. patent application Ser. No. 13/036118.

The telemetry capture system 506 is connected to the remote transmitter 512 to send the information relating to the motion of the remote object 502 to the local receiver 514 at the local site via the communications link or network 536. The communications link or network 536 is similar or the same as the communications link or network 534 and hence will not be further describe here.

The feedback system 501 at the local site comprises the vibro-kinetic encoder 510 connected to the vibro-kinetic platform 504 and to the telemetry decoder 516 which is in turn connected to the local receiver 514.

Upon receiving the information relating to the motion of the remote object 502 from the telemetry decoder 516 via the local receiver 514, the vibro-kinetic encoder 510 generates multi-channel vibro-kinetic signals for sending to the vibro-kinetic platform 504 to induce the motion to the vibro-kinetic platform 504 in accordance with the movements of the remote object 502, in real-time. Examples of embodiments of vibro-kinetic encoder 510 include digital signal processing modules or it can be embodied in software with a personal computer.

In another embodiment, the system 500 may include audio and video rendering, whereby the user may view and hear what is seen and heard by or at the remote object 502, in real time.

In order to do so, the system 500 comprises an audio capture system 528, and a video capture system 526 at the remote site generally or on (or in) the remote object 502. The audio capture system 528 and the video capture system 526 are respectively for capturing audio data and video data representative respectively of an audio and a video environment of the remote object 502. In such an embodiment, the remote transmitter 512 transmits the telemetry data, audio data and video data to the local site to be rendered on the audio playback system 520 and the video playback system 518 of the feedback system 501 by synchronously rendering motion, audio and video to the user (not shown) which normally sits in the vibro-kinetic platform 504, and operates the control interface 524.

According to another embodiment, the control interface 524 also sends its control commands directly to the vibro-kinetic encoder 510. The vibro-kinetic controls the vibro-kinetic platform 504 based on the control commands from the control interface 524 or the feedback from the remote object 502 or a combination thereof.

According to an embodiment, the method for synchronizing a vibro-kinetic signal with audio and video signals is selected from any one of those described in the applicant's granted or pending patents such as U.S. Pat. No. 6,139,324, U.S. Pat. No. 7,680,451, U.S. Pat. No. 7,321,799, and US 2010/0135641 which are hereby incorporated by reference.

Using the system 500 of FIG. 5, the user may control the motion of a remote object 502 that they watch directly; e.g., on a stage, a race-circuit, etc. and experience movements and vibrations on the vibro-kinetic platform 504 that correspond to the movements of the remote object 502, in real time. In another embodiment, using the system 500 of FIG. 5, the user may control the motion of a remote object 502 in a remote location, and watch the remote object 502 on a display (or the view from the remote object 502 on a display), hear the object on a speaker, and experience movements that correspond to the movements of the remote object 502 which is shown on the display, in real-time.

Furthermore, while the remote object 502 can be embodied in a variety of controllable moving objects such as a car, a plane, a helicopter, a boat, a minicraft, a robot, a train, etc.

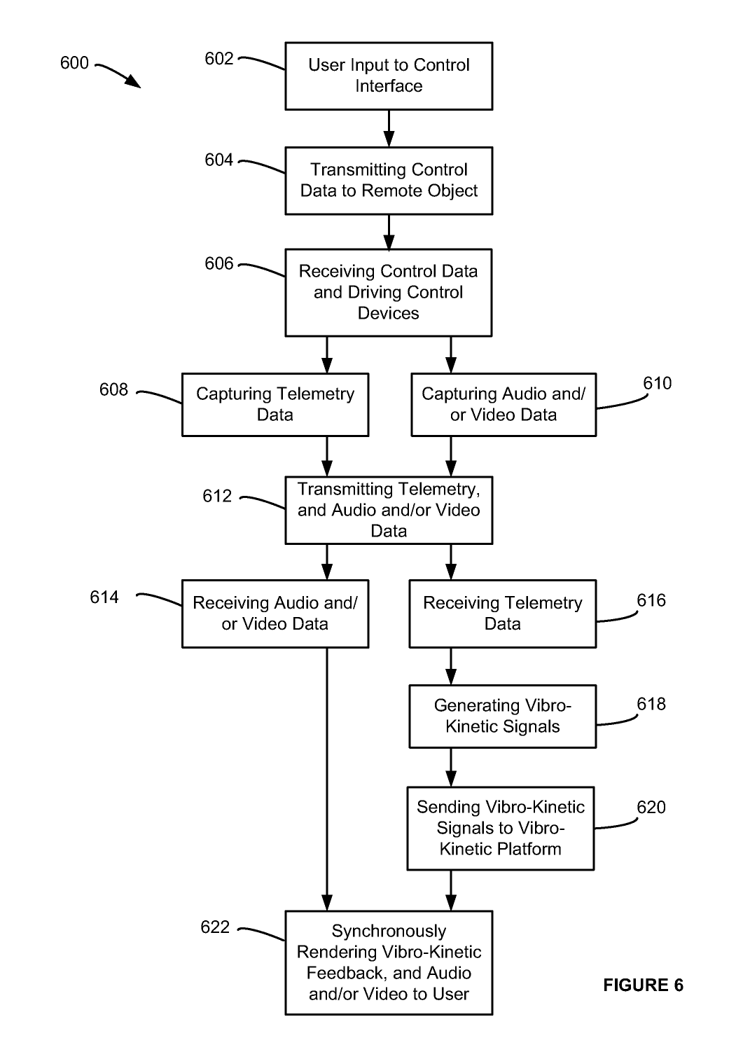

FIG. 6 is a block diagram illustrating a method 600 for controlling the motion of a remote object and rendering audio, video and motion of that object on a feedback system. The method 600 comprises: receiving a user's input to the control interface thereby producing control data (step 602); transmitting the control data to the remote object (step 604); receiving the control data and executing them on the driving control devices to control the motion of the remote object (step 606); capturing telemetry data characteristic of the remote object using the telemetry capture system (step 608); capturing audio and video data using the audio capture system and video capture system, respectively (step 610); transmitting telemetry, and audio and/or video data to the local site (step 612); receiving the audio and/or video data at the local site (step 614); receiving the telemetry data at the local site (step 616); from the telemetry data, generating a vibro-kinetic signal for inducing motion to the vibro-kinetic platform, the motion corresponding to the telemetry data representative of movements of the remote object (step 618); and sending the vibro-kinetic signal to the vibro-kinetic platform (step 620) to render vibro-kinetic feedback to the vibro-kinetic platform synchronously with an audio and/or a video produced by the audio playback system and/or the video playback system respectively, the produced audio and/or video being representative respectively of the audio and/or the video environment of the remote object thereby synchronously rendering the vibro-kinetic feedback, the audio and/or the video to the user (step 622).

According to an embodiment, the telemetry data representative of measurements of the object relate to movement or motion of the object and are in a range of frequencies between about 0 Hz and 600 Hz. Preferably, the range is between 0 and 100 Hz. Examples of telemetry data include: engine rpm, shaft rotation speed (e.g., transmission, etc.), acceleration (angular and linear (3 axes)), speed (angular and linear (3 axes)), and angular attitude. Other telemetry data also includes energy level and consumption, fluid levels and pressure measurements, alarm/malfunction/warnings indicator, wear of parts (e.g., brakes), etc.

According to another embodiment, the motion-enabled platform is replaced by another type of movement inducing device such as an exoskeleton (not shown) or any other system which can be worn by a user or which principally has an effect on the sense of touch of a user (i.e., not smell, hearing, sight or taste). An example of an exoskeleton used to control a robot is described in U.S. Pat. No. 7,410,338. In the present system, a first exoskeleton is used in controlling the movement of the user. The first exoskeleton reproduces the movements of another user. As discussed herein, the movements of the other user are obtained from sensors. The movements of the other user could also be captured by another exoskeleton.

Generation of the vibro-kinetic signals that are to be transmitted to the vibro-kinetic platform 100 is performed in real-time, with a latency that is substantially un-detectable by the user (occupant of the vibro-kinetic platform 100). The “real-time” criteria will vary depending on the contemplated application. As long as the vibro-kinetic effect is synchronized with the audio and video signals provided to the user (or what the user actually sees happening), the vibro-kinetic platform is considered to provide a vibro-kinetic effect in real-time. According to an embodiment, the latency is less than 100 milliseconds. In another embodiment, the latency is less than 10 milliseconds.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A system for rendering a vibro-kinetic feedback representative of vibro-kinetic properties of a remote object, the system comprising:
a telemetry capture system for capturing telemetry data representative of measurements related to the remote object;
a vibro-kinetic encoder for generating, using the telemetry data, a vibro-kinetic signal representative of the vibro-kinetic properties of the remote object; and
a vibro-kinetic platform to render, from the vibro-kinetic signal, the vibro-kinetic feedback representative of the vibro-kinetic properties of the remote object.

2. The system of claim 1, further comprising a control interface for generating control data for controlling motion of the remote object.

3. The system of claim 2, wherein the control interface comprises at least one of: a joystick, a steering wheel, pedals, and a keyboard.

4. The system of claim 2, wherein the control interface is embedded within the vibro-kinetic platform.

5. The system of claim 2, wherein the control interface is separate from the vibro-kinetic platform.

6. The system of claim 1, further comprising:
a video capture system for capturing a video environment of the remote object; and
a video playback system for reproducing video environment of the remote object;
wherein the vibro-kinetic encoder generates the vibro-kinetic signal such that the vibro-kinetic feedback is rendered synchronously with the reproduced video environment.

7. The system of claim 6, further comprising:
an audio capture system for capturing audio environment of the remote object; and
an audio playback system for reproducing the audio environment of the remote object;
wherein the vibro-kinetic encoder generates the vibro-kinetic signal such that the vibro-kinetic feedback is rendered synchronously with the reproduced audio environment.

8. The system of claim 1, wherein the vibro-kinetic platform is at a local site and the remote object is at a remote site remote from the local site.

9. The system of claim 8, further comprising a communication link for enabling communication between the local site and the remote site, the communication link comprising at least one of: a Bluetooth link, a WiFi link, a wireless link, an optical link, a wired link, an internet link, an Ethernet link, a radio-frequency link and an infra-red link.

10. The system of claim 1, wherein the vibro-kinetic platform comprises a motion-enabled chair.

11. The system of claim 1, wherein the vibro-kinetic platform comprises a shape of the remote object.

12. A method for rendering a vibro-kinetic feedback representative of vibro-kinetic properties of a remote object on a vibro-kinetic platform, the method comprising:
receiving telemetry data representative of measurements related to the remote object;
generating, using the telemetry data, a vibro-kinetic signal representative of the vibro-kinetic properties of the remote object; and
rendering, from the vibro-kinetic signal, the vibro-kinetic feedback representative of the vibro-kinetic properties of the remote object on the vibro-kinetic platform.

13. The method of claim 12, further comprising generating control data for execution by the remote object thereby controlling motion of the remote object.

14. The method of claim 12, further comprising capturing telemetry data by reading data from one or more sensors installed on the remote object.

15. The method of claim 14, further comprising:
capturing video data representative of a video environment of the remote object; and
synchronously rendering the video environment at a video playback system and the vibro-kinetic feedback at the vibro-kinetic platform.

16. The method of claim 15, further comprising:
capturing audio data representative of an audio environment of the remote object; and
synchronously rendering the audio environment at an audio playback system and vibro-kinetic feedback at the vibro-kinetic platform.

17. The method of claim 14, further comprising transmitting the captured telemetry data to a vibro-kinetic encoder over a communication link.

18. The method of claim 14, wherein the capturing telemetry data comprises capturing telemetry data representative of movements of the remote object in a range of frequencies between about 0 Hz and 600 Hz.

19. The method of claim 18, wherein the capturing telemetry data comprises capturing telemetry data representative of movements of the remote object in a range of frequencies between about 0 Hz and 100 Hz.

20. The method of claim 16, wherein the receiving telemetry data comprises processing at least one of the captured video data and the captured audio data to obtain computed telemetry data representative of measurements of the remote object.
